(19) United States
(12) Patent Application Publication
(10) Pub. No.: US 2011/0223554 A1
(43) Pub. Date: Sep. 15, 2011

(54) CANTILEVER ARM FOR ORTHODONTIC ANCHORAGE

(76) Inventor: Marino Musilli, Sa (IT)

(21) Appl. No.: 13/130,217

(22) PCT Filed: Oct. 30, 2009
(86) PCT No.: PCT/US2009/062716

§ 371 Date: May 19, 2011

Related U.S. Application Data
(60) Provisional application No. 61/115,948, filed on Nov. 19, 2008.

(51) Int. Cl. A61C 7/02

(52) U.S. Cl. 433/3; 433/24

(57) ABSTRACT

An orthodontic cantilever arm includes a wire segment with an outer end portion having a generally “C”-shaped configuration. One leg of the outer end portion is received in a passageway of an orthodontic anchorage device such as a temporary implant and the other leg bears against an outer surface of the anchorage device. The cantilever arm also includes an elongated arm portion, and the two legs of the outer end portion cooperate with each other to restrict certain types of movements of the arm portion.

### BACKGROUND OF THE INVENTION

1. Field of the Invention

This invention relates to methods and apparatus that are useful in orthodontic treatment in instances where a temporary anchorage device such as an implant has been placed in the patient's oral cavity.

2. Description of the Related Art

The use of temporary anchorage devices, also known as “TADs”, has long been considered an effective and reliable method of providing a fixed anchor point in the oral cavity. Temporary anchorage devices are often used to either directly move one or more teeth, or alternatively retain one or more teeth in fixed, stable positions during the time that other teeth are being moved. Temporary anchorage devices are considered an advantage compared to other types of anchorage such as extra-oral headgear and the like, because the devices are normally not visible during the course of treatment and because issues of patient compliance do not arise. Typically, temporary anchorage devices are removed from the oral cavity when no longer needed.

A variety of temporary anchorage devices are commercially available. Some types of temporary anchorage devices include a head having a slot with a rectangular cross-sectional configuration. When a wire segment having a matching rectangular cross-sectional configuration is connected to the slot by a ligature, the anchor is capable of resisting certain rotational or twisting movements of the wire segment in an arc about its longitudinal axis as well as certain bending movements (e.g., cantilever movements) of the wire segment in an arc about an axis perpendicular to its longitudinal axis.

Other types of orthodontic anchorage devices have one or more passageways that extend through a head of the device, and such passageways often have a cylindrical configuration. The cylindrical configuration can function to resist bending movements of the wire segment in an arc perpendicular to its longitudinal axis. However, when a wire segment is received in such a passageway, the cylindrical configuration of the passageway is not capable of resisting relative rotational or twisting movements of the wire segment about its longitudinal axis. As a consequence, certain types of orthodontic techniques using the wire segment are considered difficult to attain by some practitioners.

### SUMMARY OF THE INVENTION

The present invention relates to a cantilever arm for use with temporary anchorage devices, as well as associated methods of use and assemblies. In one embodiment, the cantilever arm of the present invention has an outer end portion with a generally “C”-shaped configuration, part of which is received in a hole or a through passageway of a temporary anchorage device. Another part of the outer end portion bears against an external surface of the temporary anchorage device in order to provide certain reactive forces or alternatively provide a fixed anchor point as may be desired.

The present invention provides significant advantages to the practitioner, since the cantilever arm can be coupled to the anchorage device quickly and without the need for a ligature. Yet, the outer end portion of the cantilever arm with its generally “C”-shaped configuration provides a secure coupling and is able to cooperate with a cylindrical passageway of the anchorage device in order to resist relative rotation of twisting movements of the cantilever arm relative to the anchorage device in directions about the longitudinal axis of the cantilever arm, as well as bending or cantilever movements of the arm in an arc about an axis perpendicular to its longitudinal axis.

In more detail, the present invention in one aspect is directed to an orthodontic cantilever arm comprising a wire segment. The wire segment includes an outer end portion with an outer leg, an inner leg opposite the outer leg and a curved region interconnecting the outer leg and the inner leg. The outer leg, the inner leg and the curved region together present a generally “C”-shaped configuration that lies in a certain reference plane. The wire segment also includes an elongated arm portion connected to the outer end portion, and the arm portion extends away from the outer end portion in a direction that presents a non-zero angle relative to the reference plane.

Another aspect of the present invention is directed to an orthodontic assembly. The assembly comprises an orthodontic anchorage device that includes a base for connection to a patient's bone structure in the oral cavity. The device also includes a head, a post extending between the base and the head, and a passageway. The assembly further includes a cantilever arm connected to the anchorage device. The cantilever arm includes a wire segment having an outer end portion with an outer leg, an inner leg and a curved region interconnecting the outer leg and the inner leg. The outer leg, the inner leg and the curved region together present a generally “C”-shaped configuration. The outer leg is received in the passageway, and the wire segment also includes an elongated arm portion connected to the outer end portion. The inner leg is in contact with at least one of the post and the head.

Another aspect of the present invention is directed toward a method of connecting a wire segment to an orthodontic anchorage device. The method comprises:

inserting an outer leg of the wire segment into a passageway of the anchorage device, wherein the outer leg comprises part of a generally “C”-shaped outer end portion of the wire segment, and wherein the wire segment further includes an elongated arm portion extending away from the outer end portion; and

contacting an inner leg of the outer end portion with an outer surface of the orthodontic anchorage device in order to limit movement between the arm portion and the anchorage device.

Further details of the invention are defined in the features of the claims.

### BRIEF DESCRIPTION OF THE DRAWINGS

FIG. 1 is a perspective view of an orthodontic cantilever arm constructed with one embodiment of the present invention;

FIG. 2 is a side elevational view of the cantilever arm shown in FIG. 1;

FIG. 3 is a view somewhat similar to FIG. 2 except looking at the cantilever arm in a direction that is 90 degrees from the direction of view depicted in FIG. 2;

FIG. 4 is a side elevational view of an exemplary orthodontic anchorage device;

FIG. 5 is a perspective view showing a portion of the anchorage device illustrated in FIG. 4, illustrating the anchorage device in connected relationship to the cantilever arm that is illustrated in FIGS. 1-3; and

FIG. 6 is a view somewhat similar to FIG. 5 except looking at the anchorage device and the cantilever arm in a different direction.

### DETAILED DESCRIPTION OF THE PREFERRED EMBODIMENTS

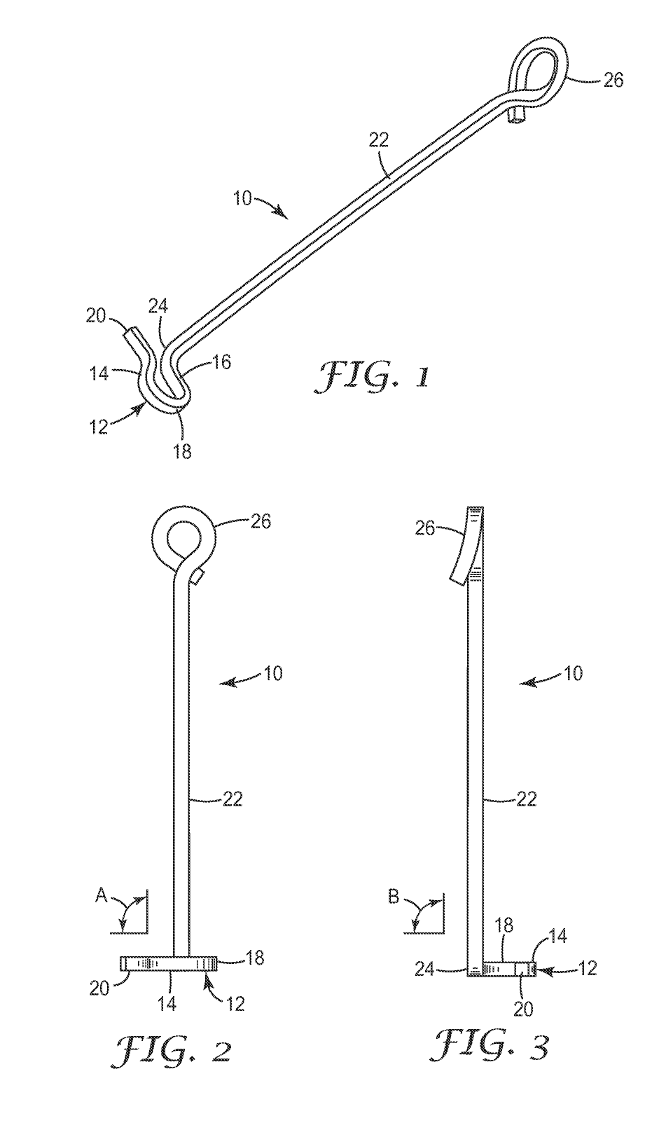

A cantilever arm for use in orthodontic treatment is broadly designated by the numeral 10 in FIGS. 1-3 and 5-6. The cantilever arm 10 includes an outer end portion 12 with an outer leg 14, an inner leg 16 and a curved region 18 that integrally interconnects the outer leg 14 and the inner leg 16. The outer leg 14, the inner leg 16 and the curved region 18 together present a generally “C”-shaped configuration.

Preferably, the outer end portion 12 of the cantilever arm also includes an outermost tail 20. Preferably, the tail 20 extends at an angle relative to the outer leg 14.

The cantilever arm 10 also includes an elongated arm portion 22 and a curved portion 24 that integrally interconnects the inner end of the arm portion 22 to the inner leg 16. The arm portion 22 extends away from the outer end portion 12 in a certain direction as may be desired by the practitioner, and a variety of different directions are possible.

In the example shown in the drawings, and with reference to FIG. 2, the outer end portion 12 lies in a reference plane that is oriented at an angle “A” relative to the longitudinal axis of the arm portion 22 when viewed in a direction toward the outer leg 16. In this example, the angle “A” is approximately 90 degrees, although other angles are also possible. FIG. 3 is another view of the cantilever arm 10 but looking in a direction 90 degrees with respect to the direction of view of FIG. 2. In FIG. 3, the direction of view is directly toward the opening presented by the “C”-shaped configuration of the outer end portion 12. As can be observed, the outer end portion 12 lies in a reference plane that is oriented at an angle designated “B” relative to the longitudinal axis of the arm portion 22. In this example, the angle “B” is approximately 90 degrees, although other angles are also possible. The angles “A” and “B” may be selected by the practitioner in accordance with the particular type of orthodontic movement or orthodontic stability that is desired.

Optionally, the cantilever arm 10 includes a coupling 26 that is connected to the arm portion 22 at a location remote from the outer end portion 12. The coupling 26 in this exemplary embodiment is a loop-shaped section, although other types of couplings and coupling configurations are also possible. For example, the coupling 26 could have a hook-shaped configuration. As another example, the coupling 26 could simply comprise a rectangular wire section of the arm 10 that has a cross-sectional configuration matching the cross-sectional configuration of a rectangular slot of an orthodontic appliance such as a bracket. As additional examples, the coupling 26 may comprise a linkage such as a chain-type linkage or a ball and socket assembly. Other couplings are also possible.

As one preferred example, the cantilever arm 10 is supplied with a relatively straight arm portion 22 when shipped to an orthodontic practitioner by the manufacturer. As a result, the practitioner is free to bend the arm portion 22 as desired once the treatment plan has been determined. For example, the practitioner could bend the outer, free end of the arm portion 22 into a loop similar to the coupling 26 for subsequent connection to a wire member. Alternatively, the practitioner could bend the outer, free end of the arm portion 22 as may be needed for insertion of the arm portion 22 into one or more slots of one or more bracket appliances.

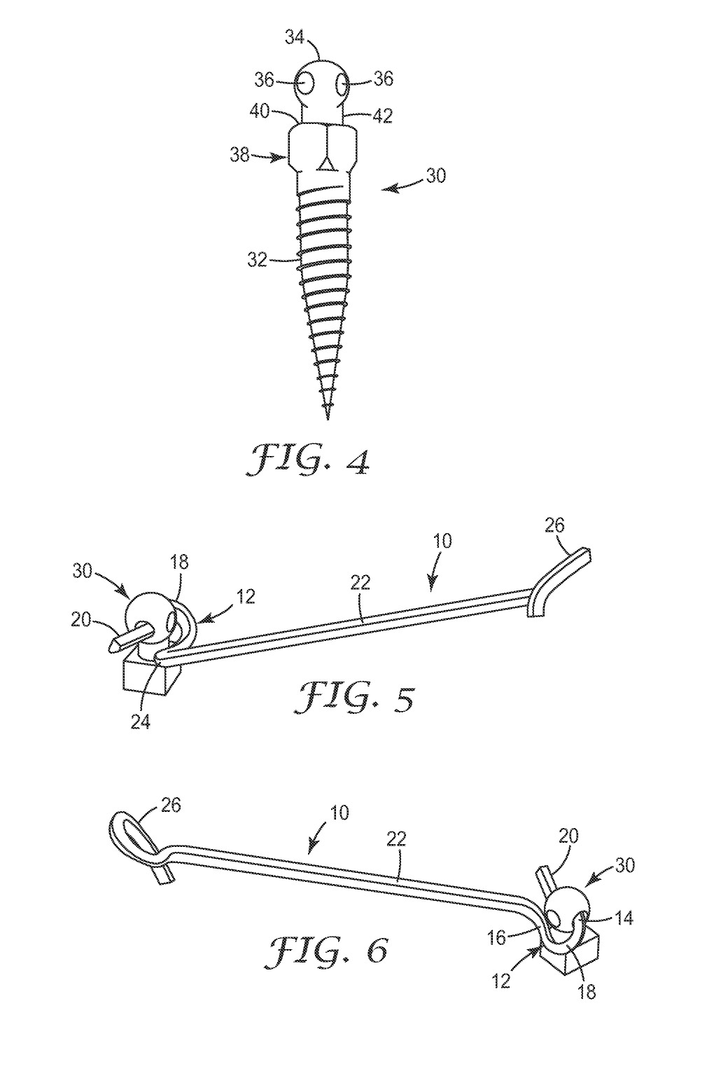

FIG. 4 is an illustration of an exemplary orthodontic anchorage device 30 that may be used with the cantilever arm 10. As shown in FIG. 4, the anchorage device 30 includes a base 32 for connection with a patient's bone structure in the oral cavity. In this example, the base 32 includes a threaded shaft having an outermost, pointed end, and the threaded shaft is preferably self-tapping. The anchorage device 30 also includes a head 34 that has a generally spherical configuration. The head 34 of the exemplary device 30 includes two intersecting passageways 36, 36. Each of the passageways 36 in this example has a cylindrical configuration and extends completely through the head 34.

The anchorage device 30 also includes a post 38 that integrally interconnects the base 32 and the head 34. The post 38 includes a central, polygonal-shaped abutment that presents a shoulder 40. In addition, the post 38 presents a recess 42 that is located between the head 34 and the shoulder 40. When the anchorage device 30 is implanted in the oral cavity, the head 34 projects above the soft tissue for enabling access to the passageways 36.

Examples of suitable anchorage devices are described in published PCT Application No. WO2004/093707. An example of a suitable commercially available anchorage device is the “Imtec” brand Ortho Implant from 3M Unitek Corporation, Monrovia, Calif. Other types of anchorage devices having one or more passageways for receiving a wire segment may also be used, including implants having one or more passageways that extend through a post or neck of the device instead of a head of the device. As another alternative, an onplant may be used instead of an implant. For example, the onplant described in U.S. Pat. No. 5,066,224 may be suitable in some instances if it is modified to be provided with a through passageway.

FIGS. 5 and 6 illustrate the cantilever arm 10 in coupled relation to the anchorage device 30. As shown, the outer end portion 12 is received in one of the passageways 36 in such a manner that the outer leg 14 lies within the passageway 36 and the tail 20 extends beyond the head 34. If desired, the practitioner may bend the tail 20 to an angle that is greater than the angle shown in the drawings in order to further help ensure that the cantilever arm 10 does not inadvertently detach from the anchorage device 30.

When the cantilever arm 10 is in the orientation shown in FIGS. 5 and 6 relative to the anchorage device 30, the inner leg 16 is in contact with an outer surface of the post 38. Optionally, the inner leg 16 is also in contact with an adjacent region of the head 34. Preferably, and as shown, the inner leg 16 is partially received in the recess 42 and is in contact with the shoulder 40. The shoulder 40 provides a relatively hard stop for movement of the outer end portion 12. For example, if a downward force (viewing FIG. 5) is directed on the coupling 26, the shoulder 40 would serve to limit movement of the outer end portion 12 in an arc about the central axis of the passageway 36 that receives the outer leg 14. If the amount of downward force is sufficiently large, the arm portion 22 may bend as the inner leg 16 bears against the shoulder 40, but further rotational movement of the outer end portion 12 is effectively precluded.

In addition, since the orientations of the outer leg 14 and the associated passageway 36 are disposed at an angle relative to the longitudinal axis of the arm portion 22, rotational or twisting movement of the cantilever arm 10 about the longitudinal axis of the arm portion 22 is restricted. Such movements may also be restricted by contact of the inner leg 16 with the shoulder 40, depending upon the selected geometry of the end portion 12 and the anchorage device 30.

Preferably, the cantilever arm 10 is constructed of a resilient material that is suitable for use in the oral cavity, such as a single, unitary segment of metallic wire having a round, rectangular or square cross-sectional configuration. Suitable metallic materials include alloys of nickel titanium, beta titanium and stainless steel. Consequently, when the inner leg 16 is in contact with the shoulder 40, the arm portion 22 may bend when a downward force is directed to the coupling 26 viewing FIG. 6. However, due the resiliency and the inherent memory of the stainless steel material, the arm portion 22 will tend to move back to its straight configuration as shown in the drawings whenever the downward force directed onto the coupling 26 is released.

The cantilever arm 10 in combination with an anchorage device such as the device 30 is useful for a variety of orthodontic procedures. For example, the cantilever arm 10 may be used to move impacted teeth, to upright the molar teeth, to correct a midline deviations in a patient's dental arch, to expand sectors of the dental arch to treat dental asymmetry, and to realize and control the torque movement of the teeth. The cantilever arm 10 is also useful to provide expansion or contraction of the upper and/or lower dental arches (either on one side only of a dental arch, or on both sides simultaneously, and without the need to use a trans-palatal arch device).

The cantilever arm 10 can be used for procedures that involve directly moving teeth and procedures that involve indirectly moving teeth. Examples of procedures that involve directly moving teeth include connection of the cantilever arm 10 to one or more teeth in such a manner that the resiliency of the arm portion 22 when bent serves to exert a force on the teeth. In these examples, the location of the anchorage device 30 and the length and configuration of the cantilever arm 10 are selected so that the arm portion 22 is bent from its normal, relaxed configuration when tooth movement is desired. As the arm portion 22 tends to return to its normal orientation, the resiliency of the arm portion 22 serves to exert a force on the tooth or teeth connected to the coupling 26.

An example of use of the cantilever arm 10 in an indirect force application involves stabilizing the position of one or more teeth. For instance, the arm portion 22 may be relaxed when connected to a certain tooth that is to be stabilized. If a force exerted against such tooth due to the movement of other teeth, the arm portion 22 along with the inherent rigidity of the anchorage device 30 serve to retain the tooth in a fixed position.

All of the patents and patent applications mentioned above are hereby incorporated into the present disclosure. Moreover, a number of variations are possible. As such, the present invention should not be deemed limited to the exemplary embodiments described above, but instead only by a fair scope of the claims that follow along with their equivalents.

1. An orthodontic cantilever arm comprising a wire segment having an outer end portion with an outer leg, an inner leg opposite the outer leg and a curved region interconnecting the outer leg and the inner leg, wherein the outer leg, the inner leg and the curved region together present a “C”-shaped configuration that lies in a certain reference plane, wherein the wire segment also includes an elongated arm portion connected to the outer end portion, and wherein the arm portion extends away from the outer end portion in a direction that presents a non-zero angle relative to the reference plane, wherein the non-zero angle is approximately 90 degrees.

2. An orthodontic cantilever arm according to claim 1 wherein the arm portion has a generally straight configuration.

3. An orthodontic cantilever arm according to claim 1 wherein the outer end portion also includes an outermost tail that is connected to the outer leg, and wherein the outermost tail extends at an angle relative to the outer leg.

4. An orthodontic cantilever arm according to claim according to claim 1 wherein the cantilever arm further includes a coupling connected to the arm portion at a location remote from the outer end portion.

5. An orthodontic cantilever arm according to claim according to claim 4 wherein the coupling has a loop-shaped configuration.

6. An orthodontic cantilever arm according to claim according to claim 4 wherein the coupling has a hook-shaped configuration.

7. An orthodontic assembly comprising:
an orthodontic anchorage device including a base for connection to a patient's bone structure in the oral cavity, the device also including a head, a post extending between the base and the head, and a passageway; and
a cantilever arm connected to the anchorage device, the cantilever arm including a wire segment having an outer end portion with an outer leg, an inner leg and a curved region interconnecting the outer leg and the inner leg, wherein the outer leg and the inner leg and the curved region together present a generally “C”-shaped configuration, wherein the outer leg is received in the passageway, wherein the wire segment also includes an elongated arm portion connected to the outer end portion, and wherein the inner leg is in contact with at least one of the post and the head.

8. An orthodontic assembly according to claim 7 wherein the outer end portion lies in a certain reference plane, and wherein the arm portion extends away from the outer end portion in a direction that presents a non-zero angle relative to the reference plane.

9. An orthodontic assembly according to claim 7 wherein the outer end portion also includes an outermost tail that is connected to the outer leg, and wherein the outermost tail extends at an angle relative to the outer leg.

10. An orthodontic assembly according to claim 7 wherein the post includes a shoulder, and wherein the inner leg is in contact with the shoulder.

11. An orthodontic assembly according to claim 7 wherein the post includes a recess located between the shoulder and the head, and wherein the inner leg is partially received in the recess.

12. An orthodontic assembly according to claim 11 wherein the inner leg is in contact with the shoulder.

13. An orthodontic assembly according to claim 7 wherein the passageway extends through the head.

14. An orthodontic assembly according to claim 7 wherein the base of the anchorage device includes a threaded shaft.

15. A method for connecting a wire segment to an orthodontic anchorage device, the method comprising:
inserting an outer leg of the wire segment into a passageway of the anchorage device, wherein the outer leg comprises part of a generally “C”-shaped outer end portion of the wire segment, and wherein the wire segment further includes an elongated arm portion extending away from the outer end portion; and
contacting an inner leg of the outer end portion with an outer surface of the orthodontic anchorage device in order to limit movement between the arm portion and the anchorage device.

16. The method of claim 15 and including the act of implanting the anchorage device in the oral cavity of the patient.

17. The method of claim 15 wherein the act of contacting an inner leg of the outer end portion with an outer surface of the orthodontic anchorage device includes the act of at least partially receiving the inner leg in a recess of the orthodontic anchorage device.

18. The method of claim 15 wherein the act of contacting an inner leg of the outer end portion with an outer surface of the orthodontic anchorage device includes the act of contacting a shoulder of the orthodontic anchorage device.
